(19) United States
(12) Patent Application Publication
(10) Pub. No.: US 2024/0426339 A1
(43) Pub. Date: Dec. 26, 2024

(54) Thrust Washer for Distributing a Fluid with Lubricant Pockets

(71) Applicant: E. WINKEMANN GmbH, Plettenberg (DE)

(72) Inventors: Tim Rennen, Olpe (DE); Tino Gadomski, Plettenberg (DE); Detlev Dehne, Herscheid (DE)

(21) Appl. No.: 18/736,897

(22) Filed: Jun. 7, 2024

(30) Foreign Application Priority Data
Jun. 23, 2023 (DE) 102023205957.6
May 20, 2024 (EP) 24173876.4

(51) Int. Cl. F16C 17/04

(52) U.S. Cl. CPC F16C 17/045

(57) ABSTRACT

A thrust washer having a central bore extending parallel to a rotational axis of the thrust washer for pushing the thrust washer onto a journal or a shaft; a first thrust surface and a second thrust surface that are arranged substantially parallel to one another, the first thrust surface having a first lubricant pocket in the form of a depression in the first thrust surface, and/or the second thrust surface having a second lubricant pocket in the form of a depression in the second thrust surface, the first lubricant pocket or the second lubricant pocket being connected fluidically to the respective other thrust surface or to a respective corresponding first or second lubricant pocket by a channel which runs substantially parallel to the rotational axis axially through the thrust washer, the first and/or the second lubricant pocket taper outward in the radial direction relative to the rotational axis.

### CROSS-REFERENCE TO RELATED APPLICATIONS

This application claims priority to DE102023205957.6 dated Jun. 23, 2023 and to EP 24173876.4 dated May 20, 2024, all of which are hereby incorporated by reference herein in their entireties for all purposes.

### FIELD

The invention relates to a thrust washer for distributing a fluid with a central bore for pushing onto a journal or a shaft, and to a planetary transmission.

### BACKGROUND

Thrust washers are used, in particular, in motor vehicles. For example, thrust washers are used in the engine and in the drive trains of vehicles, the thrust washers preferably being used in planetary transmissions. Here, the thrust washers are arranged between the planetary gears and the planetary carrier on the planetary journals. The wear can advantageously be reduced by way of the use of a thrust washer between the planetary carrier and the planetary gear. By way of the increased pressure forces, the thrust washer generates a perpendicularly acting force which is transmitted by the lubricant to the counterpart and therefore separates the friction partners from one another. The planetary carriers are often not hardened and threaten to fail as the service life progresses as a result of the constant wear. Therefore, the thrust washer has a positive effect, in particular, on the service life of a planetary transmission of this type.

In a similar manner, thrust washers are used at locations in the engine or at further positions in the drive train. Furthermore, the thrust washer can be used in further transmission forms or in the case of electric machines, in order to reduce the wear between rotating components in an analogous way.

Thrust washers are already known from the prior art. DE 10 2013 104 129 B3 describes a thrust washer for pushing onto a journal or a shaft, the thrust washer having at least one lubricant pocket on the respective two flat thrust surfaces. In each case one lubricant pocket of the respective thrust surface has a corresponding lubricant pocket on the other thrust surface, the corresponding lubricant pockets being connected by means of a channel which runs axially through the thrust washer. In this way, the lubricant which collects in the lubricant pockets can be transported to the other side of the thrust washer. The lubricant pockets are of triangular configuration, and one tip of the triangle is directed radially inward. Furthermore, the feed channel runs through the radially inwardly directed tip, the feed channel transporting lubricant into the lubricant pocket. If the thrust washer rotates, the lubricant is pressed into the lubricant pockets by the centrifugal force. The triangular lubricant pocket widens radially toward the outside, merely a relatively low pressure therefore arising at the lubricant pockets. On the other side, the lubricant which is conveyed outward by the rotation generates a negative pressure on the thrust washer, as a result of which the thrust washer is pulled in the direction of the next component to be lubricated. As a result of the present contour and the increased centrifugal forces in the case of novel drives (such as, for example, electric motors), the lubricant can be conveyed outward more rapidly by way of the outwardly open shape, and the achieved lifting effect can no longer have an optimum action as a consequence. This effect of separating the thrust washer and the opposing bodies is additionally influenced, in addition, as a result of changed lubricant in the case of novel drives (for example, lower viscosity). Furthermore, the aim is for the thrust washer to be of as flat and compact a configuration as possible, since the installation space in the drive trains of a vehicle, and in the engine, is highly limited.

### BACKGROUND

Against this background, the object is to provide a thrust washer of the type mentioned at the outset which, in a space-saving manner, reduces the risk of wear of the mechanical components, between which the thrust washer is arranged.

The object is achieved by way of a thrust washer for distributing a fluid, the thrust washer having a central bore, extending parallel to a rotational axis of the thrust washer, for pushing the thrust washer onto a journal or a shaft, the thrust washer having a first thrust surface and a second thrust surface, the first thrust surface and the second thrust surface being arranged, in particular, substantially parallel to one another, the first thrust surface having a first lubricant pocket in the form of a depression in the first thrust surface, and/or the second thrust surface having a second lubricant pocket in the form of a depression in the second thrust surface, the first lubricant pocket or the second lubricant pocket being optionally connected fluidically to the respective other thrust surface or to a respective corresponding first or second lubricant pocket by means of a channel which runs, in particular, substantially parallel to the rotational axis axially through the thrust washer, the first and/or the second lubricant pocket in each case tapering outward in the radial direction in relation to the rotational axis.

The thrust washer according to the invention is advantageously distinguished by the fact that the tapering in the radial direction to the outside, in relation to the rotational axis, of the first and/or the second lubricant pocket generates a higher pressure by way of the lubricant. By way of the centrifugal force, the rotational movement presses a fluid, in particular a lubricant, into the lubricant pockets of the thrust washer. The tapering of the lubricant pockets produces a cross-sectional area reduction of the lubricant pocket. This cross-sectional area reduction makes an increase in the prevailing pressure in the lubricant pockets in comparison with the prior art possible. An increase in the prevailing pressure at the lubricant pocket can counteract, in particular, the generated negative pressure on the thrust washer as a result of the displaced fluid. It is conceivable, in particular, that the thrust washer therefore achieves an equilibrium of forces more rapidly, the thrust washer not being pulled closer in the direction of one of the components to be lubricated. The pressure which arises at the lubricant pockets arises, in particular, by virtue of the fact that the thrust washer can be arranged close to the components to be lubricated, an intermediate space possibly being present as a result of the lubricant pocket and the component in bearing contact. Furthermore, the lubricant is moved from the lubricant pockets onto the respective thrust surface, the lubricant film which arises in the process lubricating the components to be lubricated.

According to the invention, the thrust washer serves to distribute a fluid, in particular a lubricant. The thrust washer can have a main extent plane, the thrust washer preferably being of thin-walled configuration. Furthermore, the thrust washer can have a round cross-sectional area. According to the invention, the thrust washer has a first and a second thrust surface, the first and the second thrust surface preferably being arranged in a substantially flat manner and particular preferably parallel to the main extent plane. The thrust washer can be arranged between two components to be lubricated, these components being arranged, in particular, parallel to one another. Accordingly, it can be advantageous that the first and second thrust surface are arranged substantially parallel to one another. The components to be lubricated are, furthermore, often connected via a journal, an axle or a shaft. In order to arrange the thrust washer, for example, between the components to be lubricated, the thrust washer has, according to the invention, a central bore which extends parallel to a rotational axis of the thrust washer for pushing onto the axle, the journal or the shaft. Here, the rotational axis can be defined primarily by the axle, the journal or the shaft. Moreover, the first thrust surface can have a first lubricant pocket, and the second thrust surface can have a second lubricant pocket.

Within the context of this application, lubricant pockets are understood to be depressions in the respective thrust surfaces. For instance, the first lubricant pocket can be configured in the form of a depression on the first thrust surface. This also applies in an analogous way to the second lubricant pocket. A first lubricant pocket and/or a second lubricant pocket are/is preferably connected fluidically to a respective other corresponding lubricant pocket or to the respective other thrust surface by means of a channel which runs, in particular, substantially parallel to the rotational axis axially through the thrust washer. This channel can make the exchange of lubricant possible between the first lubricant pocket and the second lubricant pocket, or a lubricant pocket with the respective other thrust surface. The channel can either run substantially parallel to the rotational axis axially through the thrust washer, or can run at an angle with respect to the rotational axis through the thrust washer. Therefore, the lubricant can ensure lubrication on the first thrust surface and on the second thrust surface, it being possible for the closest component to be lubricated on the first thrust surface and for the next component to be lubricated on the second thrust surface. As an alternative, there can be no fluidic connection or no channel between the first thrust surface and the second thrust surface. A thrust surface can advantageously thus not be lubricated, in order to produce different frictional torques. Depending on the application, accordingly only the adjacent component can be spaced apart from the thrust washer by means of lubricant which is arranged on the respective thrust surface which has a lubricant pocket. It is conceivable that one thrust surface requires more lubricant, it being possible for the connecting channel to be oriented in such a way that a lubricant flow in one direction is favored. Thus, for example, the channel can extend in an angular region between 0 and 10°, starting from a first thrust surface, relative to the rotational axis toward the second thrust surface. During operation, therefore, the lubricant delivery in the direction of the second thrust surface would be boosted by way of the channel. The centrifugal force can press the lubricant along the channel in the direction of the second thrust surface. This applies in an analogous way to the second thrust surface, the channel extending in an angular region between 0 and 10°, starting from the second thrust surface, relative to the rotational axis in the direction of the first thrust surface. It is conceivable that merely the first or the second lubricant pocket or both of the first and second lubricant pockets tapers/taper outward in the radial direction in relation to the rotational axis. This would be particularly preferred if the tensile force generated by way of the negative pressure is to be compensated for merely on one side of the thrust washer. Merely one thrust surface preferably has a lubricant pocket, this lubricant pocket particularly preferably being connected fluidically by way of the above-described channel to the respective other thrust surface.

It is provided in accordance with one alternative embodiment of the invention that the first thrust surface has a plurality of first lubricant pockets, and/or the second thrust surface has a plurality of second lubricant pockets, the first lubricant pockets and the second lubricant pockets being arranged, in particular, in a corresponding manner with respect to one another, the first and/or the second lubricant pockets of the respective first or second thrust surface being spaced apart from one another in a circumferential direction. A first lubricant pocket on the first thrust surface can have a corresponding second lubricant pocket on the second thrust surface. Corresponding can be understood in such a way that the two lubricant pockets are structurally identical and/or are arranged in a circumferential direction at an identical position on the respective thrust surface. Therefore, the fluid connection by means of the channel can be configured to be as short as possible. Furthermore, a substantially perpendicular bore with respect to the first or second thrust surface is relatively simple to produce, in particular in terms of manufacturing technology. The thrust washer preferably has a plurality of first and/or a plurality of second lubricant pockets, there preferably being, in particular, a corresponding second lubricant pocket for each first lubricant pocket. Further preferably, merely the first thrust surface can also have a plurality of first lubricant pockets, or only the second thrust surface can have a plurality of second lubricant pockets, without the respective other thrust surface having first or second lubricant pockets. Therefore, a thrust washer can have lubricant pockets on only one side or thrust surface. With an increasing number of lubricant pockets on the respective thrust surfaces, an equilibrium of forces between the tensile force which is generated by way of the negative pressure in the direction of one of the components in bearing contact and the counter-pressure which is generated by way of the lubricant can advantageously arise more rapidly. It is thus conceivable that the first thrust surface has from two to eight first lubricant pockets, and the second thrust surface has from two to eight second lubricant pockets. In order to avoid, in particular, inhomogeneous forces on the thrust washer, the first and/or second lubricant pockets are preferably spaced apart from one another in the circumferential direction, in particular are spaced apart from one another to a maximum extent. It is conceivable here that, in the case of a circular thrust washer, the possible angular range (here, for example, 360°) is divided by the number of respective lubricant pockets on the respective thrust surface. In the case of two first lubricant pockets, the lubricant pockets are preferably arranged in the circumferential direction at an angle of 180° with respect to one another.

It is provided in accordance with a further alternative refinement of the invention that the first and/or the second thrust surface have/has, in addition to the first and/or the second lubricant pocket, at least one further lubricant pocket. In addition to the first and/or the second lubricant pockets, the first and/or the second thrust surface can have further lubricant pockets. These further lubricant pockets do not necessarily have a corresponding further lubricant pocket on the respective other thrust surface, however. Furthermore, the further lubricant pockets preferably do not have any channel which run substantially parallel to the rotational axis axially through the thrust washer. The further lubricant pockets are preferably arranged in the circumferential direction between the first and/or second lubricant pockets on the first and/or second thrust surface. The further lubricant pocket can taper outward in the radial direction in relation to the rotational axis, the same effects being brought about in this way as by way of the first and second lubricant pockets. A further lubricant pocket preferably does not have any fluidic connection with the respective other thrust surface; this makes it possible for a pressure to be generated by way of the lubricant in the further lubricant pocket, without permitting a flow of lubricant to the respective other thrust surface. It is conceivable that the lubricant flow to the respective other thrust surface generates a slight pressure drop; this slight pressure drop is then to be avoided at the further lubricant pocket. Moreover, it is conceivable that one thrust surface has at least one respective lubricant pocket, and the respective other thrust surface has merely one or a plurality of further lubricant pockets. Here, the respective lubricant pocket of the one side can be connected to the other thrust surface via the channel, and the other thrust surface has one or more further lubricant pockets without being connected fluidically to the thrust surface. It is to be conceivable, for example, that the first thrust surface has one or more first lubricant pockets which are fluidically connected either to the second thrust surface or to a corresponding second lubricant pocket. In this example, the first lubricant pocket is fluidically connected to the second thrust surface, it being possible for the second thrust surface to have one or more further lubricant pockets, without having a second lubricant pocket. These are in turn not fluidically connected directly to the first thrust surface.

It is provided in an alternative refinement of the invention that the total number of lubricant pockets on the first thrust surface and the total number of lubricant pockets on the second thrust surface differ from one another. The total number of lubricant pockets can be determined from the number of first lubricant pockets and the number of further lubricant pockets on the first thrust surface. This applies in an analogous way to the total number of lubricant pockets on the second thrust surface. Thus, for example, the first thrust surface can have more lubricant pockets than the second thrust surface, it being entirely conceivable that the second thrust surface does not have any second or further lubricant pockets. In this way, for example, a controlled tensile force might be used as a result of the negative pressure on one of the thrust surfaces. In the case of a different number of lubricant pockets, it would be conceivable that the thrust surface with the smaller number of lubricant pockets tends to be pulled in the direction of the closest component.

It is provided in accordance with a further refinement of the invention that the first and/or the second lubricant pocket extend/extends as far as an inner wall which is formed by the central bore. The thrust washer preferably has an annular cross section in the main extent plane, there being a central bore according to the invention for pushing onto a journal or a shaft. The thrust washer can have an inner end side and an outer end side, these end sides being arranged substantially perpendicularly with respect to the first and the second thrust surface. The cylindrical inner wall which is formed by the central bore can be considered to be an inner end side. The central bore can have a substantially circular cross-sectional area. The first and/or the second and/or the further lubricant pocket preferably extend outward in the radial direction, starting from the inner wall. Furthermore, it is considered to be preferred that the lubricant pockets have an inlet region, through which the lubricant flows into the lubricant pockets, this inlet region being arranged on the edge which is arranged toward the inner wall, and following the curvature of the inner wall on the entire width of the inlet region. This has a positive effect, in particular, on the lubricant flow into the respective lubricant pocket. A wider inlet which follows the curvature of the inner wall makes a greater flow of lubricant into the lubricant pockets possible.

It is provided in a further refinement of the invention that the first and/or the second and/or the further lubricant pocket is connected fluidically via a feed channel in the form of a depression to the inner wall. The feed channel can be manufactured to be wider or narrower in a manner which is dependent on the application. This makes a controlled inflow of lubricant into the respective lubricant pockets in a manner which is adapted to the respective application possible.

It is provided in accordance with a further alternative refinement of the invention, that the first and/or the second and/or the further lubricant pocket have/has a recess region, the recess region of the respective lubricant pockets being arranged on the inner wall, the recess region preferably being arranged centrally on the respective lubricant pocket. The recess region can be a cutout on the inner wall of the thrust washer, these cutouts being arranged, in particular, centrally on the respective lubricant pockets. The recess region preferably extends from the first thrust surface as far as the second thrust surface. In addition to, for example, an axial channel, a flow of lubricant between the first thrust surface and the second thrust surface can advantageously be made possible in this way. Furthermore, the recess region can collect the lubricant, it being possible for this accumulation of lubricant to be introduced directly below the respective lubricant pockets as it were directly into the lubricant pockets. In this way, local lubricant accumulations advantageously arise in the recess regions.

It is provided in accordance with one alternative refinement of the invention that the first and/or the second thrust surface have/has at least one discharge channel, a first and a second discharge channel being arranged in the form of a depression on the respective first or the second thrust surface, a first discharge channel extending, starting from one of the first lubricant pockets, in the radial direction outward as far as a radial end side of the thrust washer, and a second discharge channel extending, starting from one of the second lubricant pockets, in the radial direction outward as far as the radial end side of the thrust washer. The discharge channel can discharge the lubricant from the respective thrust surfaces toward the outside. This makes active cooling of the thrust washer and the components in bearing contact possible, in particular in a positive manner. Cooler lubricant can be fed to the thrust washer, it being possible for coolant which has already been heated to be discharged by way of the discharge channel. For this purpose, the discharge channel preferably extends from an outer (in the radial direction) edge of the lubricant pocket as far as the outer end side. The cross-sectional area of the depression of the discharge channel can be designed in a manner which is dependent on the application; a greater cross section would make a greater cooling effect possible. The pressure which cannot be generated as a result of the escaping lubricant and the presumed lubricant consumption which does not serve directly for lubricant film formation on the first and/or the second thrust surface have a disadvantageous effect, however.

It is provided in accordance with a further alternative refinement of the invention that the depressions of the first and/or the second and/or the further lubricant pockets are triangular or trapezoidal. The depressions of the respective lubricant pockets are preferably produced by means of stamping, grinding or milling. The thrust washer is preferably produced from a metal; it is conceivable in the case of a relatively soft metal that the depressions are made in the respective thrust surfaces by means of a pressing method. Furthermore, a respective depression can have a triangular or trapezoidal cross-sectional area. The shapes are suitable, in particular, for implementing the tapering according to the invention of the depressions. As an alternative, it would be conceivable that the depressions have a diamond-shaped cross-sectional area, a first widening of the cross section being followed by the tapering according to the invention. The first widening of the cross-sectional area has a positive effect here, in particular, on the lubricant quantity to be received. In addition, the edges of the depressions are preferably of substantially straight configuration. As an alternative, however, it is conceivable that the edges of the depressions of the respective lubricant pockets are curved. The edges can firstly be curved in the direction of the center of the respective lubricant pocket, or can be curved outward in the circumferential direction. The curvature inward leads to increased tapering of the depressions, and can further increase the hydrodynamic pressure which arises as a result of the lubricant during operation. Curvature outward can lead to it being possible for more lubricant to be collected in the respective lubricant pockets, but this can have a negative effect on the pressure which can be generated by way of the lubricant.

It is provided in accordance with one alternative refinement of the invention that the first and/or the second lubricant pocket each have/has an intermediate surface and at least one transition surface, the intermediate surface extending substantially parallel to the respective thrust surface, and the transition surface extending in the circumferential direction outward toward the respective thrust surface, this transition surface being arranged, in particular, at an angle with respect to the intermediate surface. The intermediate surface is preferably arranged centrally between two transition surfaces. It is conceivable, furthermore, that the first and the second lubricant pocket also has, toward the outside in the radial direction, a transition surface which is arranged at an angle with respect to the intermediate surface and extends toward the respective thrust surface. The respective transition surfaces advantageously have an effect, in particular, on the pressure generation by way of the lubricant, the transition surfaces representing a further cross-sectional reduction. Furthermore, the transition surfaces make a gentle transition of the lubricant to the respective thrust surface possible, it being possible for a more homogeneous lubricant film to be formed. It is conceivable that merely one transition surface is arranged on the rear edge in the circumferential direction, in relation to the rotational direction. The rotational direction in combination with the transition surface makes the gentle lubricant transfer possible.

It is provided in one alternative refinement of the invention that the first and/or the second and/or the further lubricant pocket have/has two transition surfaces, these transition surfaces extending, starting from the center of the lubricant pocket, in the circumferential direction in opposed directions toward the respective thrust surface. In particular, the transition surfaces are preferably arranged at an angle with respect to the respective thrust surface.

It is provided in accordance with one alternative refinement of the invention that the thrust washer is of curved or arched or spherical configuration. Within the context of this invention, spherical can be understood to be part of a spherical surface, the thrust washer preferably comprising a part region of the spherical surface of less than 50%, particularly preferably less than 40%. The thrust washer can have a curvature radius which is adapted, in particular, to the respective application. Specific applications would be, for example, in drive technology, in particular in ball bearings, axle drives or differentials. A thrust washer of this type is preferably used as a ball retaining ring.

In a further preferred refinement of the invention, the first and the second thrust surface are of substantially flat configuration. This can be advantageous, in particular, if the thrust washer is arranged between two substantially parallel components, with the result that the thrust washer should be of flat configuration, in order to ensure lubrication in as optimum a manner as possible.

A further subject matter of the invention is a planetary transmission with at least one thrust washer in accordance with one of the preceding embodiments, the thrust washer being arranged between a planetary carrier and a planetary gear.

The above-stated refinements, advantages or technical effects of the first and second lubricant pockets can also be applied to the further lubricant pockets.

The thrust washer according to the invention and the above-stated refinements are preferably used for the lubrication of rotating components in constricted spaces. Advantageous fields of application are, in particular, in automotive technology here, automotive technology also including electromobility. The thrust washer is preferably used, in particular, in the drive trains.

Further details and advantages of the invention are to be explained in the following text on the basis of the exemplary embodiments shown in the drawings, in which:

### BRIEF DESCRIPTION OF THE FIGURES

FIG. 1 shows a first exemplary embodiment of a first thrust surface of a thrust washer according to the invention in a front view,

FIG. 2 shows a first exemplary embodiment of a second thrust surface of the thrust washer according to the invention (shown in FIG. 1) in a front view,

FIG. 3a shows a sectional view through a first and a second lubricant pocket of the first exemplary embodiment from FIG. 1 and FIG. 2,

FIG. 3b shows a sectional view through a further lubricant pocket of a first thrust surface and a further lubricant pocket of a second thrust surface of the first exemplary embodiment of the thrust washer shown in FIG. 1 and FIG. 2,

FIG. 4 shows a sectional view of one exemplary embodiment of a planetary transmission with a thrust washer, and

FIG. 5 shows a sectional view of a second exemplary embodiment of a thrust washer according to the invention.

### DETAILED DESCRIPTION

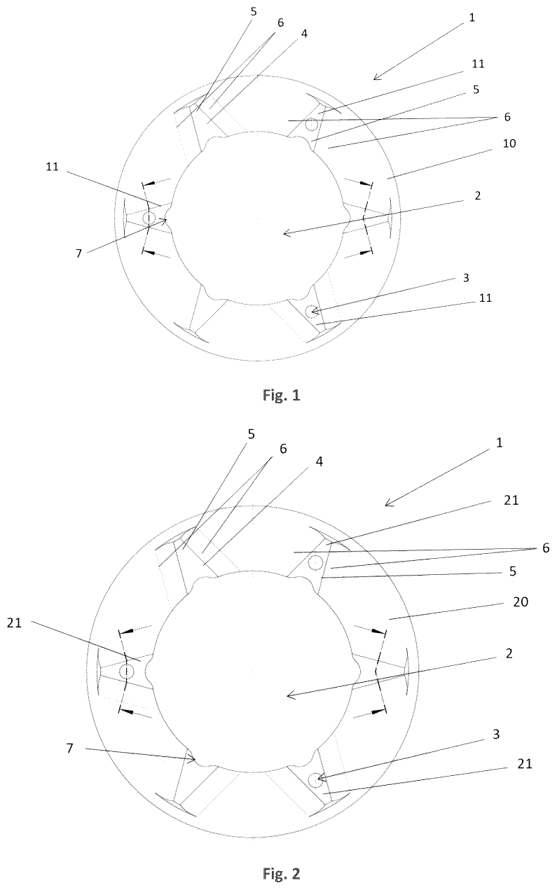

FIG. 1 shows a first exemplary embodiment of a first thrust surface 10 of a thrust washer 1 according to the invention. The thrust washer 1 serves primarily to distribute a fluid, it being possible, in particular, for the fluid to be a lubricant. The thrust washer 1 can be installed next to one or between a plurality of rotating components, the thrust washer 1 lubricating the components in an advantageous way.

For this purpose, the thrust washer 1 from the first exemplary embodiment has a first substantially flat thrust surface 10. Furthermore, the thrust washer 1 from the first exemplary embodiment has a second substantially flat thrust surface 20 which is arranged substantially parallel to the first thrust surface 10. The second thrust surface 20 is shown in FIG. 2.

In order to use the thrust washer 1, in particular, in the drive train of a vehicle, preferably a motor vehicle, the thrust washer 1 has a central bore 2. According to the invention, the second bore 2 extends parallel to a rotational axis of the thrust washer 1. Furthermore, it is conceivable that the center point of the central bore 2 lies on the rotational axis of the thrust washer 1. By means of the central bore 2, the thrust washer 1 can be pushed onto an axle, shaft or a journal of the respective application. Via the axle, shaft or the journal, the thrust washer 1 can be arranged with the thrust surface 10 on or close to the component to be lubricated, the first thrust surface 10 having a first lubricant pocket 11 in the form of a depression. In the application case, the first lubricant pocket 11 can be filled with the lubricant by way of a rotational movement of the thrust washer 1. Here, the lubricant is pressed outward by way of the rotation and the therefore prevailing centrifugal force. The lubricant can collect in the first lubricant pocket 11, it being possible for a hydrodynamic pressure to be generated in the first lubricant pocket 11 by way of the prevailing centrifugal force in combination with the lubricant. This acts firstly as a cushion between the thrust washer 1 and the component to be lubricated, and secondly the prevailing force can press the lubricant through a channel 3 arranged in the first lubricant pocket 11. Furthermore, the lubricant is transported by way of the first lubricant pocket 11 onto the first thrust surface 10, and therefore serves for the formation of a lubricant film. The channel 3 is arranged substantially parallel to the rotational axis of the thrust washer 1, and extends axially through the thrust washer 1. Furthermore, the channel 3 is a fluidic connection between the first thrust surface 10 and the second thrust surface 20. As an alternative, the channel 3 can extend through the thrust washer 1 at an angle with respect to the rotational axis. As a further alternative, a thrust surface 10, 20 without a channel 3 is conceivable, with the result that there is no fluidic connection through the thrust washer 1 between the respective thrust surfaces 10, 20. This makes it possible to generate different frictional torques on the respective thrust surfaces 10, 20, the number of lubricant pockets 11, 21 on one thrust surface 10, 20 differing to this end from the number of lubricant pockets 11, 21 on the respective other thrust surface 10, 20. It is conceivable here that one thrust surface 10, 20 does not have any lubricant pocket 11, 21, with the result that the thrust surface 10, 20 is substantially fixed on an adjacent object as a result of the increased frictional resistance.

The centrifugal force which prevails as a result of the rotational movement of the thrust washer 1 can displace the lubricant out of the region of the central bore 2 and can force it into the first lubricant pocket 11. Here, in particular, a negative pressure which is generated by way of the displaced lubricant arises. This negative pressure pulls the thrust washer 1 onto the close component to be lubricated, or onto one of the two close components to be lubricated. This effect can cause, in particular, further wear if it is not counteracted by the pressure which arises as a result of the lubricant which is present in the lubricant pockets 11, 21. According to the invention, the first and/or the second lubricant pocket 11, 21 taper/tapers to the outside in the radial direction in relation to the rotational axis. In the first exemplary embodiment, the first and the second lubricant pocket 11, 21 taper to the outside. The lubricant which is displaced to the outside is advantageously compressed to a greater extent, by way of the change in cross section, and generates a hydrodynamic pressure which counteracts the negative pressure. For this purpose, the first lubricant pocket 11 or a further lubricant pocket 4 preferably has a triangular or trapezoidal cross section.

In the present first exemplary embodiment, the first lubricant pocket 11 has an intermediate surface 5 and two transition surfaces 6. The intermediate surface is arranged substantially parallel to the respective thrust surface (here, the first thrust surface 10). As an alternative, it is conceivable that the intermediate surface 5 rises radially toward the outside; this can ensure, in particular, a further pressure rise by way of the lubricant. The lubricant pockets 11, 4 can have an intermediate surface 4, the depth of the intermediate surface 4 decreasing in the radial direction to the outside. Here, the depth can be the spacing between the intermediate surface 4 and the level of the first thrust surface 10. Furthermore, the transition surfaces 6 preferably extend outward in the circumferential direction toward the respective thrust surface (here, the first thrust surface 10). In this way, an, in particular, gentle transfer of the lubricant onto the first thrust surface 10 can be made possible. The arrangement of two transition surfaces 6 make this gentle transition possible regardless of the rotational direction of the thrust washer 1. If the thrust washer 1 rotates merely in one direction, it is conceivable that the edge which is arranged toward the outside in the circumferential direction and at the rear in the rotational direction has only one transition surface 6.

It is apparent from FIG. 1 that the first thrust surface 10 has a plurality of first lubricant pockets 11. It is conceivable that a first thrust surface 10 has from two to eight first lubricant pockets 11. In the present exemplary embodiment, the first thrust surface 10 has three first lubricant pockets 11, these lubricant pockets being spaced apart from one another in a circumferential direction. The first lubricant pockets 11 are preferably spaced apart from one another to a maximum extent. In FIG. 1, the first lubricant pockets 11 are spaced apart from one another at an angle of 120°. Further lubricant pockets 4 are arranged centrally in the circumferential direction between the first lubricant pockets 11. The further lubricant pockets 4 also have an intermediate surface 5 and two transition surfaces 6. If a first thrust surface 10 has first lubricant pockets 11 and further lubricant pockets 4, the total angle is preferably divided by the total number of lubricant pockets, in order to determine the respective angular spacings from one another. It is preferred, in particular, that the first lubricant pockets 11 are arranged in an alternating manner with the further lubricant pockets 4. Thus, a further lubricant pocket 4 is to be arranged next to a first lubricant pocket 11, a first lubricant pocket 11 in turn following this further lubricant pocket 4.

The lubricant pockets 11, 4 on the first thrust surface 10 are advantageously arranged uniformly, in order to provide a lubricant film which is as homogeneous as possible on the first thrust surface 10.

Furthermore, FIG. 1 shows that the first and the further lubricant pockets 11, 4 extend as far as an inner wall which is formed by way of the central bore 2. In addition, the lubricant pockets 11, 4 each have a recess region 7 on the inner wall of the central bore 2. This recess region is arranged centrally in the present example, in relation to the respective lubricant pocket 11, 4. The recess region 7 can be a cutout which can collect lubricant in an inlet region of the lubricant pockets 11, 4. The thrust washer 1 can be pushed onto an axle, shaft or a journal, the latter bearing proportionally against the inner wall of the thrust washer 1. The recess region 7 preferably does not bear directly against the axle, shaft or the journal, lubricant advantageously being collected here in this way.

In FIG. 1, the first and the further lubricant pocket 11, 4 do not extend as far as the outer (in the radial direction) end side of the thrust washer 1. If the depression of the respective lubricant pocket extended as far as the outer end side of the thrust washer 1, hydrodynamic pressure might not be generated. It would be conceivable, however, that one or more first and/or further lubricant pockets 11, 4 has/have a discharge channel in the form of a depression, a first discharge channel extending, starting from one of the first lubricant pockets 11, in the radial direction outward as far as a radial end side of the thrust washer 1. A further discharge channel can extend, starting from one of the further lubricant pockets 4, in the radial direction outward as far as a radial end side of the thrust washer 1. This would make an exchange of lubricant possible and, in particular, would make the cooling of the components in contact and the thrust washer 1 possible.

FIG. 2 shows the rear side of the first exemplary embodiment of the thrust washer 1 from FIG. 1. A second thrust surface 20 with three second lubricant pockets 21 and three further lubricant pockets 4 is shown here. The second lubricant pockets 21, in particular, correspond to the first lubricant pockets 11, the latter being connected fluidically via the channel 3. As an alternative, there does not have to be a fluidic connection between the first thrust surface 10 and the second thrust surface 20. The lubricant can be transported through the channel 3, for example, from a first lubricant pocket 11 to the corresponding second lubricant pocket 21. In the present exemplary embodiment, the further lubricant pockets 4 are arranged on the second thrust surface 20 in a corresponding manner to the further lubricant pockets 4 of the first thrust surface 10. This is not absolutely necessary, however. It is therefore conceivable that the total number of lubricant pockets 11, 21, 4 on the respective thrust surface 10, 20 varies. It is also conceivable that the first thrust surface 10 has a plurality of further lubricant pockets 4, and the second thrust surface 20 has no or few further lubricant pockets 4.

As an alternative, it is to be noted that either the first or the second thrust surface 10, 20 does not necessarily have to have lubricant pockets 11, 21, 4. It would thus be conceivable in the first exemplary embodiment that the first thrust surface 10 looks as shown in FIG. 1, but the second thrust surface 20 does not have any second lubricant pockets 21. A fluidic connection can be further established, however, via the channel 3 between the first lubricant pocket 11 and the second thrust surface 20 or, as an alternative, there is no fluidic connection between the respective thrust surfaces 10, 20. This applies analogously if the second thrust surface 20 looks as shown in FIG. 2 for the first thrust surface 10. This makes a one-sided lubricant pocket arrangement possible, as a result of which, for example, production costs can be lowered. Depending on the application, a single-sided lubricant pocket arrangement can be sufficient. The thrust washer 1 can advantageously be manufactured from tempered steel, nitro-carburized steel or bronze. It goes without saying that other materials are likewise possible.

In the case of the second thrust surface 20 from FIG. 2, the same advantages, technical effects and exemplary embodiments which have already been explained in conjunction with the first thrust surface 10 from FIG. 1 can be achieved.

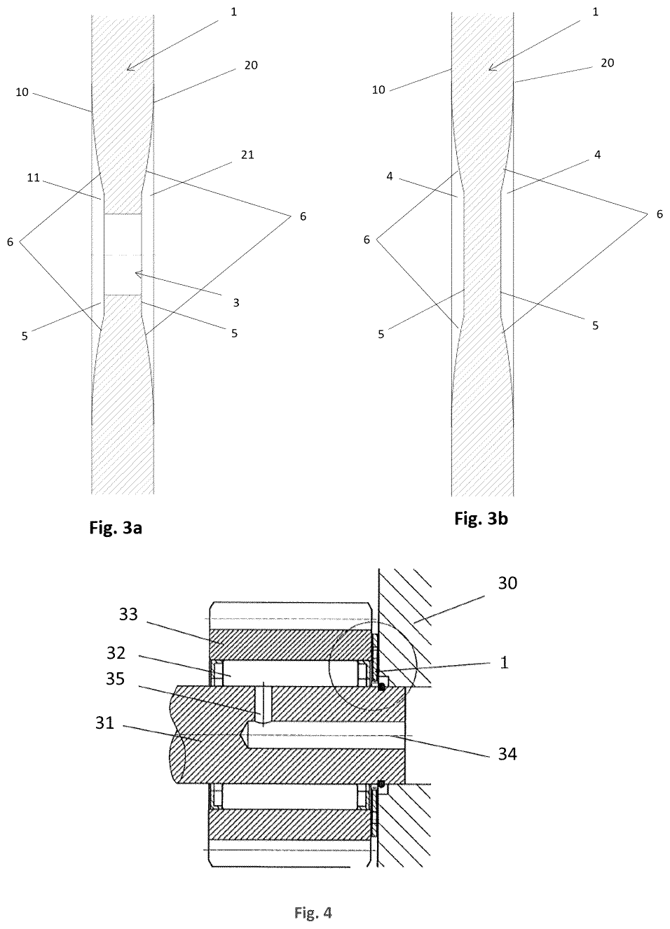

FIGS. 3a and 3b each show a sectional view through the first exemplary embodiment (shown in FIG. 1 and FIG. 2) of the thrust washer 1. It can be seen in FIG. 3a that the first lubricant pocket 11 is connected to the second lubricant pocket 21 via a channel 3. It is clearly apparent from FIG. 3b that the further lubricant pockets 4 of the respective first thrust surface 10 and the second thrust surface 20 are not fluidically connected by means of a channel.

A sectional illustration of a planetary transmission with a thrust washer 1 is depicted in FIG. 4. The planetary transmission has a planetary carrier 30, a planetary journal 31, a needle row 32 and planetary gears 33. The thrust washer 1 is arranged on the planetary journal 31 between the end sides of the needle row 32 and a planetary gear 33 on one side and the planetary carrier 30 on the other side. A lubricant channel 34 and a further lubricant channel 35, via which the lubricant supply for the needle row 32 is made possible, are arranged in the planetary journal. From there, the lubricant passes into the recess regions 7 of the thrust washer 1 and further into the lubricant pockets 11, 21, 4 of the thrust washer 1.

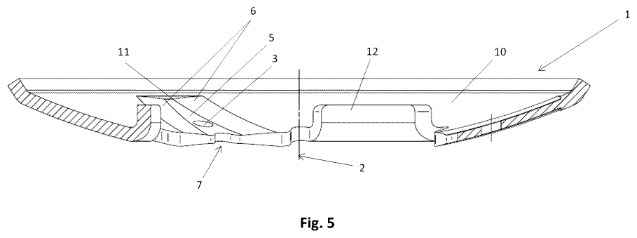

FIG. 5 shows a second exemplary embodiment of a thrust washer 1 according to the invention. The second exemplary embodiment shows a curved or arched or spherical thrust washer 1. To this end, the thrust washer 1 has a curvature radius which is preferably determined by way of the respective application. The second thrust surface 20 is curved toward the outside, the first thrust surface 10 being arranged so as to lie on the inside. Furthermore, the second exemplary embodiment shows a positioning element 12 in the form of a web which makes precise positioning possible.

It is also conceivable here that merely one or the two thrust surfaces 10, 20 has/have a lubricant pocket arrangement 11, 21. The second exemplary embodiment shows merely first lubricant pockets 11 on the first thrust surface 10. The second thrust surface 20 does not have any lubricant pockets 21 in the present exemplary embodiment.

As an alternative, the second thrust surface 20 can have one or more lubricant pockets 21, and the first thrust surface 10 does not have any lubricant pockets 11.

The second exemplary embodiment of the thrust washer 1 is preferably used as a ball retaining ring.

In the case of the second exemplary embodiment from FIG. 5, the same advantages, technical effects and exemplary embodiments which have already been explained in conjunction with the first exemplary embodiment can be achieved, unless ruled out by the curved or arched or spherical shape.

In the following text, possible embodiments of the thrust washer 1 according to the invention and the planetary transmission according to the invention will be described.

Embodiment 1 relates to a thrust washer 1 for distributing a fluid, the thrust washer 1 having a central bore 2 which extends parallel to a rotational axis of the thrust washer 1 for pushing the thrust washer 1 onto a journal or a shaft, the thrust washer 1 having a first substantially flat thrust surface 10 and a second substantially flat thrust surface 20, the first thrust surface 10 and the second thrust surface 20 being arranged substantially parallel to one another, the first thrust surface 10 having a first lubricant pocket 11 in the form of a depression in the first thrust surface 10, the second thrust surface 20 having a second lubricant pocket 21 in the form of a depression in the second thrust surface 20, the first and the second lubricant pocket 10, 20 being fluidically connected to one another by means of a channel 3 which runs substantially parallel to the rotational axis axially through the thrust washer 1, the first and/or the second lubricant pocket 10, 20 tapering to the outside in each case in the radial direction in relation to the rotational axis.

Embodiment 2 relates to a thrust washer 1 in accordance with embodiment 1, the first thrust surface 10 having a plurality of first lubricant pockets 11, and the second thrust surface 20 having a plurality of second lubricant pockets 21 which correspond to the first lubricant pockets 11, the first and the second lubricant pockets 11, 21 of the respective first or second thrust surface 10, 20 being spaced apart from one another in a circumferential direction.

Embodiment 3 relates to a thrust washer 1 in accordance with embodiments 1 or 2, the first and/or the second thrust surface 10, 20 having, in addition to the first and the second lubricant pocket 11, 21, at least one further lubricant pocket 4.

Embodiment 4 relates to a thrust washer 1 in accordance with one of embodiments 1 to 3, the first and the second lubricant pocket 11, 21 extending as far as an inner wall which is formed by way of the central bore 2.

Embodiment 5 relates to a thrust washer 1 in accordance with embodiment 3, the first and/or the second and/or the further lubricant pocket 11, 21, 4 having a recess region 7, the recess region 7 of the respective lubricant pockets 11, 21, 4 being arranged on the inner wall, the recess region 7 preferably being arranged centrally on the respective lubricant pocket 11, 21, 4.

Embodiment 6 relates to a thrust washer 1 in accordance with one of embodiments 1 to 5, the first and/or the second thrust surface 10, 20 having at least one discharge channel, a first and a second discharge channel being arranged in the form of a depression on the respective first or the second thrust surface 10, 20, a first discharge channel extending, starting from one of the first lubricant pockets 11, in the radial direction outward as far as a radial end side of the thrust washer 1, and a second discharge channel extending, starting from one of the second lubricant pockets 11, in the radial direction outward as far as the radial end side of the thrust washer 1.

Embodiment 7 relates to a thrust washer 1 in accordance with one of embodiments 1 to 6, the depressions of the first and/or the second and/or the further lubricant pockets 11, 21, 4 being triangular or trapezoidal.

Embodiment 8 relates to a thrust washer 1 in accordance with one of embodiments 1 to 7, the first and the second lubricant pocket 11, 21 each having an intermediate surface 5 and at least one transition surface 6, the intermediate surface 5 extending substantially parallel to the respective thrust surface 10, 20, and the transition surface 6 extending in the circumferential direction outward to the respective thrust surface 10, 20, this transition surface 6 being arranged, in particular, at an angle with respect to the intermediate surface 5.

Embodiment 9 relates to a planetary transmission with at least one thrust washer 1 as discussed herein, the thrust washer 1 being arranged between a planetary carrier 30 and a planetary gear 33.

### LIST OF REFERENCE NUMERALS

1—Thrust washer
2—Central bore
3—Channel
4—Further lubricant pocket
5—Intermediate surface
6—Transition surface
7—Recess region
10—First thrust surface
11—First lubricant pocket
12—Positioning element
20—Second thrust surface
21—Second lubricant pocket
30—Planetary carrier
31—Planetary journal
32—Needle row
33—Planetary gear
34—Lubricant channel
35—Further lubricant channel

1. A thrust washer for distributing a fluid, the thrust washer comprising:
a central bore extending parallel to a rotational axis of the thrust washer for pushing the thrust washer onto a journal or a shaft;
a first thrust surface and a second thrust surface, the first thrust surface and the second thrust surface being arranged substantially parallel to one another, the first thrust surface having a first lubricant pocket that is a depression in the first thrust surface and/or the second thrust surface having a second lubricant pocket that is a depression in the second thrust surface, the first lubricant pocket or the second lubricant pocket being optionally connected fluidically to the respective other thrust surface or to a respective corresponding first or second lubricant pocket by a channel which runs substantially parallel to the rotational axis axially through the thrust washer,
wherein the first lubricant pocket and/or the second lubricant pocket tapers outward in a radial direction relative to the rotational axis of the thrust washer.

2. The thrust washer as claimed in claim 1, wherein the first thrust surface has a plurality of first lubricant pockets and/or the second thrust surface has a plurality of second lubricant pockets, the first lubricant pockets and the second lubricant pockets being arranged in a corresponding manner with respect to one another, the first lubricant pockets and/or the second lubricant pockets being spaced apart from one another in a circumferential direction.

3. The thrust washer as claimed in claim 1, wherein the first thrust surface and/or the second thrust surface has, in addition to the first lubricant pocket and/or the second lubricant pocket, at least one further lubricant pocket.

4. The thrust washer as claimed in claim 1, wherein the first lubricant pocket and/or the second lubricant pocket extends as far as an inner wall which is formed by the central bore.

5. The thrust washer as claimed in claim 3, wherein the first lubricant pocket and/or the second lubricant pocket and/or the further lubricant pocket has a recess region, the recess region being arranged on the inner wall, the recess region being arranged centrally on the respective lubricant pocket.

6. The thrust washer as claimed in claim 1, wherein the first thrust surface and/or the second thrust surface has at least one discharge channel, a first discharge channel and a second discharge channel being arranged in the form of a depression on the respective first thrust surface or the second thrust surface, a first discharge channel extending, starting from one of the first lubricant pockets, in the radial direction outward as far as a radial end side of the thrust washer, and a second discharge channel extending, starting from one of the second lubricant pockets, in the radial direction outward as far as the radial end side of the thrust washer.

7. The thrust washer as claimed in claim 6, wherein the depressions of the first lubricant pocket and/or the second lubricant pocket and/or the further lubricant pocket are triangular or trapezoidal.

8. The thrust washer as claimed in claim 1, wherein the first lubricant pocket and/or the second lubricant pocket each have an intermediate surface and at least one transition surface, the intermediate surface extending substantially parallel to the respective thrust surface, and the transition surface extending in the circumferential direction outward toward the respective thrust surface, the transition surface being arranged at an angle with respect to the intermediate surface.

9. The thrust washer as claimed in claim 1, wherein the thrust washer is of a curved or arched or spherical configuration.

10. A planetary transmission with at least one thrust washer as claimed in claim 1, the thrust washer being arranged between a planetary carrier and a planetary gear.
